(19) United States
(12) Patent Application Publication
(10) Pub. No.: US 2003/0037823 A1
(43) Pub. Date: Feb. 27, 2003

(54) Regulator valve for fuel pump

(76) Inventor: Dale M. Pickelman, Saginaw, MI (US)

Correspondence Address: Delphi Technologies, Inc., Legal Staff - Intellectual Property, P.O. Box 5052, Troy, MI, 48007, US

(21) Appl. No.: 09/935,165

(22) Filed: Aug. 22, 2001

(51) Int. Cl. F16K 15/00

(52) U.S. Cl. 137/543.13

(57) ABSTRACT

A regulator valve for a fuel pump of a vehicle includes a valve housing adapted to be disposed in an outlet member of the fuel pump. The regulator valve also includes a valve adjuster disposed within the valve housing and a valve seat disposed within the valve housing and spaced from the valve adjuster. The regulator valve further includes a valve member having an aerodynamic shape disposed within the valve housing and having a closed position to engage the valve seat to prevent fuel from flowing through the outlet member and an open position determined by the valve adjuster to allow fuel to flow through the outlet member.

### TECHNICAL FIELD

The present invention relates generally to fuel pumps for vehicles and, more particularly, to a regulator valve for a fuel pump of a vehicle.

### BACKGROUND OF THE INVENTION

It is known to provide a fuel tank in a vehicle to hold fuel to be used by an engine of the vehicle. It is also known to provide a fuel pump inside the fuel tank to pump fuel to the engine. Typically, the fuel pump includes a regulator valve to allow fuel to exit the fuel pump. The regulator valve generally consists of a valve device, typically a ball or poppet, which cooperates with a seat. The poppet regulator valve typically provides low flow restriction at an increased cost, which is undesired. In addition, the regulator valve has a flow through the seat with a relatively large pressure rise or gain with increasing flow rate, which is undesired.

Therefore, it is desirable to provide a regulator valve in a fuel pump for a vehicle that minimizes the pressure rise of flow through the valve. It is also desirable to provide a regulator valve for a fuel pump without compromising low flow restriction. It is further desirable to provide a regulator valve for a fuel pump at a relatively low cost.

### SUMMARY OF THE INVENTION

It is, therefore, one object of the present invention to provide a new regulator valve for a fuel pump of a vehicle.

It is another object of the present invention to provide a regulator valve for a fuel pump that has a streamlined flow path.

It is yet another object of the present invention to provide a new regulator valve for a fuel pump that has a relatively low cost and low flow restriction.

To achieve the foregoing objects, the present invention is a regulator valve for a fuel pump of a vehicle including a valve housing adapted to be disposed in an outlet member of the fuel pump. The regulator valve also includes a valve adjuster disposed within the valve housing and a valve seat disposed within the valve housing and spaced from the valve adjuster. The regulator valve further includes a valve member having an aerodynamic shape disposed within the valve housing and having a closed position to engage the valve seat to prevent fuel from flowing through the outlet member and an open position determined by the valve adjuster to allow fuel to flow through the outlet member.

One advantage of the present invention is that a new regulator valve is provided for a fuel pump of a vehicle. Another advantage of the present invention is that the regulator valve has an aerodynamic shape and seat design to provide a streamlined flow path from entrance to exit with minimal energy loss. Yet another advantage of the present invention is that the regulator valve has an airfoil hull shape fluid mechanics to drive the lowest coefficient of drag forces on the valve for high Reynolds's number flows. Still another advantage of the present invention is that the regulator valve has a relatively low cost and improves fuel pump performance and efficiency. A further advantage of the present invention is that the regulator valve has simplicity of design and relatively low cost.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a fragmentary elevational view of a regulator valve, according to the present invention, illustrated in operational relationship with a fuel pump.

FIG. 2 is an enlarged fragmentary elevational view of the regulator valve of FIG. 1 illustrating a closed position.

FIG. 3 is a view similar to FIG. 2 illustrating adjustment of a valve adjuster of the regulator valve.

### DESCRIPTION OF THE PREFERRED EMBODIMENT

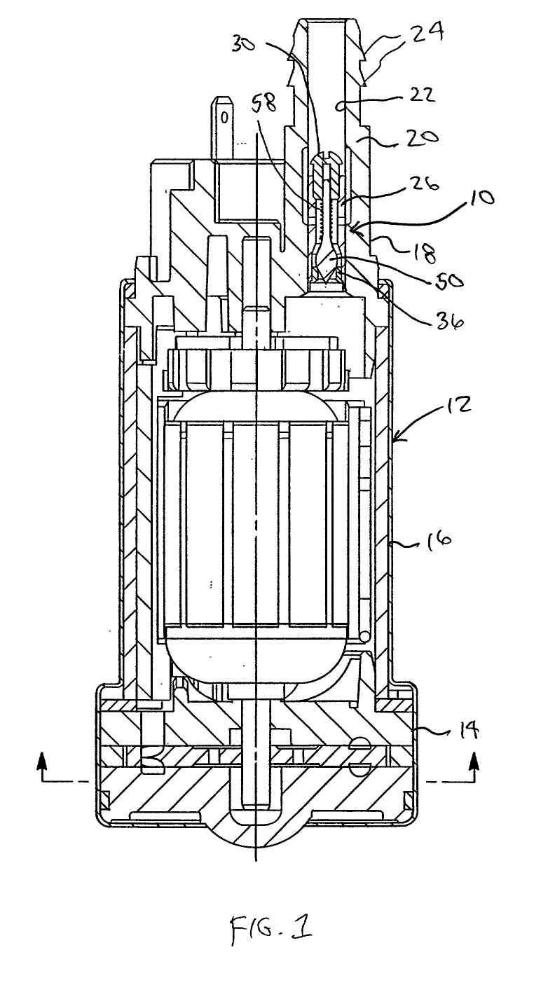

Referring to the drawings and in particular FIGS. 1 through 3, one embodiment of a check or regulator valve 10, according to the present invention, is shown for a fuel pump, generally indicated at 12, of a vehicle (not shown). The fuel pump 12 includes a pump section 14 at one axial end, a motor section 16 adjacent the pump section 14 and an outlet section 18 adjacent the motor section 16 at the other axial end. As known in the art, fuel enters the pump section 14, which is rotated by the motor section 16, and is pumped past the motor section 16 to the outlet section 18. The outlet section 18 has an outlet member 20 extending axially with a passageway 22 extending axially therethrough. The outlet member 20 also has a plurality of projections or barbs 24 extending radially outwardly for attachment to a conduit (not shown). The outlet member 20 also receives the regulator valve 10 to be described in the passageway 22. It should be appreciated that the fuel flowing to the outlet section 18 flows into the outlet member 20 and through the passageway 22 and the regulator valve 10 when open to the conduit. It should also be appreciated that, except for the regulator valve 10, the fuel pump 12 is conventional and known in the art.

Referring to FIGS. 1 through 3, the regulator valve 10 includes a valve housing 26 extending axially and disposed in the passageway 22 of the outlet member 20. The valve housing 26 has a body portion 27 that is generally tubular in shape and has a generally circular cross-sectional shape. The body portion 27 extends axially and has a first passageway 28 extending axially therethrough and a second passageway 29 extending radially or diametrically therethrough and communicating with the first passageway 28. It should be appreciated that the first passageway 28 has an enlarged diameter portion 28a at one end thereof for a function to be described.

The regulator valve 10 also includes a valve adjuster 30 disposed in the first passageway 28 of the valve housing 26 at one end thereof. The valve adjuster 30 is of a screw type and has a head 31 extending radially and a shaft 32 extending axially from the head 31 with a plurality of threads 33a disposed about the shaft 32 extending radially to engage corresponding threads 33b on the body portion 27. The valve adjuster 32 has a cavity 34 extending axially in one end of the shaft 32 for a function to be described. The cavity 34 has a generally circular cross-sectional shape. The head 31 may include a slot 35 extending diametrically therethrough to receive a tool (not shown) such as a screwdriver to turn or rotate the valve adjuster 30 to move the valve adjuster 30 axially relative to the valve housing 26. The valve housing 26 and valve adjuster 30 are made of a rigid material such as plastic and formed by suitable molding processes such as injection molding. It should be appreciated that the valve adjuster 30 is a monolithic structure being integral, unitary, and one-piece. It should also be appreciated that the valve housing 26 is a monolithic structure being integral, unitary, and one-piece. It should further be appreciated that the threads 33b on the valve housing 26 are disposed on one side of or above the second passageway 29.

The regulator valve 10 includes a valve seat 36 disposed in the first passageway 28 at the enlarged portion 28a end of the valve housing 26 and spaced axially from the valve adjuster 30 of the valve housing 26. The valve seat 36 has a body portion 38 that is generally cylindrical in shape with a generally circular cross-sectional shape. The valve seat 36 also has an aperture 40 extending axially through the body portion 38. The valve seat 36 has a recess 42 at one end thereof communicating with the aperture 40 for a function to be described. The valve seat 36 also has a flange 44 extending radially from the body portion 38 and disposed annularly thereabout to engage a surface 46 of the first passageway 28 of the body portion 27 of the valve housing 26. The valve seat 36 is made of a rigid material such as plastic and formed by suitable processes such as injection molding. It should be appreciated that the valve seat 36 may have an enlarged opening 48 in the aperture 40 opposite the recess 42.

The regulator valve 10 also includes a valve member 50 disposed in the first passageway 28 of the valve housing 26 between the valve guide 30 and the valve seat 36 and cooperating therewith. The valve member 50 is of an aerodynamic shape and extends axially. The valve member 50 has a hub 52 with a tip 54. The hub 52 has an airfoil hull shape for an outer surface 53 to provide a low co-efficient of drag for a three-dimensional body. The outer surface 53 provides an eighteen degree (18°) blended backside flow passage for low cavitations and Eddy flows. The hub 52 has a seat diameter to maximum valve diameter ratio of a predetermined amount such as 0.75 for reducing restriction with a valve stability factor of a predetermined amount such as one (1). The tip 54 has a cone shape with an inclusive angle of a predetermined amount such as sixty-four degrees (64°) to enhance stability of the valve member 50 as the fluid stream enters the seat area and the valve area. The tip 54 extends into the aperture 40 of the valve seat 36 and engages the recess 42 in a closed position. The valve member 50 also has a stem 56 extending axially from the hub 52. The stem 56 is generally cylindrical with a generally circular cross-sectional shape. The stem 56 is disposed in the cavity 34 of the valve adjuster 30 for sliding movement therein. The stem 56 has a length to diameter ratio greater than a predetermined amount such as four (4) to provide balance between valve length and stem diameter, resulting in better stability and/or reduction of wobble/rattle in the fluid stream. The valve member 50 has a first or closed position engaging the valve seat 36 to close the aperture 40 of the valve seat 36 as illustrated in FIG. 2. The valve member 46 has a second or open position determined by the valve adjuster 30 to open the aperture 40 in the valve seat 36. The valve member 50 is made of a rigid material such as plastic. It should be appreciated that fluid such as fuel flows through the aperture 40 in the valve seat 36, past the valve member 50 and out the second passageway 29 when the valve member 50 is in the open position. It should also be appreciated that the co-efficient of drag on the valve member 50 is approximately 0.1 at Reynolds's Number approaching normal operating conditions for fuel flow.

The regulator valve 10 further includes a spring 58 to urge the valve member 50 toward the valve seat 36. The spring 58 is of a coil type. The spring 58 is disposed about the stem 56 of the valve member 50 between the hub 52 and the valve adjuster 30. It should be appreciated that the spring 58 urges the tip 54 of the hub 52 to engage the recess 42 of the valve seat 36 in a closed position. It should also be appreciated that the valve member 50 needs turbulent flow for actual stability and therefore a high spring rate is desirable not only for cracking pressures at engine demand pressures (low flow rates), but to maintain Reynolds's Numbers in the range of cracking pressure annular flow areas (high flow rate). It should further be appreciated that the spring 58 is conventional and known in the art.

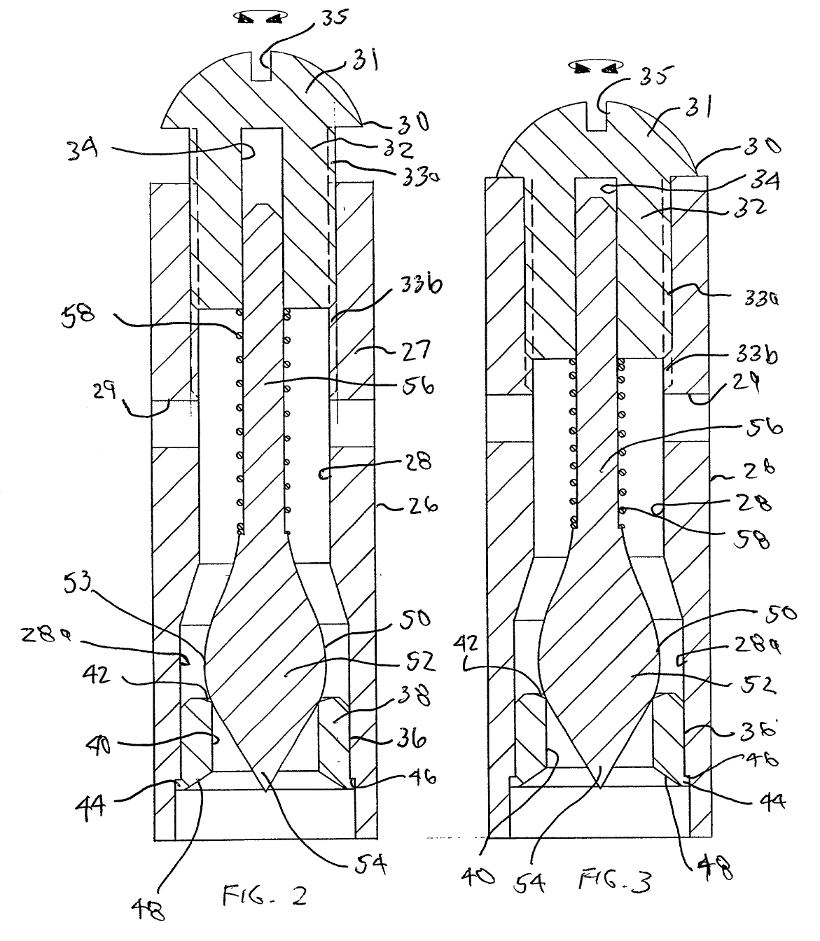

In operation, the regulator valve 10 is illustrated in an assembled state in which the valve housing 26 is disposed in the passageway 22 of the outlet member 20 of the fuel pump 12. The valve member 50 engages the valve seat 36 in the closed position as illustrated in FIG. 2. The valve member 50 is contained on the valve seat 36 by the spring 58. Fuel enters the outlet member 20 when the fuel is pumped by the pump section 14 past the motor section 16 to the outlet section 18. In normal operating conditions where the flow of the fuel pump 12 is greater than 20 g/s to the regulator valve 10, fuel flows to the aperture 40 in the valve seat 36 and causes the valve member 50 to move from the recess 42 in the valve seat 36. The valve member 50 moves to an open position, which is the maximum position desired off of the valve seat 36 as determined by the valve adjuster 30. In the open position, the valve member 50 allows fuel to flow through the aperture 40 and around the hub 52 of the valve member 50 and through the first passageway 28 and out the second passageway 29 of the valve housing 26. Fuel flows from the regulator valve 10 through the passageway 22 of the outlet member 20 to the conduit. In the open position, the valve member 50 is contained and retained in the center of the fuel flow stream by the valve adjuster 30, which guides the stem 56 of the valve member 50. At low flow conditions, the position of the valve member 50 is determined by the spring rate of the spring 58 and distance of the valve member 50 off of the valve seat 36. In the open or retained position, the valve member 50 has a low co-efficient of drag and low flow restriction versus differential pressure across the valve member 50 compared to competitor and current conventional check valves. As illustrated in FIG. 3, the valve adjuster 30 may be rotated by a tool (not shown) to increase or decrease the spring force of the spring 58 on the valve member 50 and to set a maximum open position of the valve member 50. It should be appreciated that when demand brings flow through the seat area on the valve regulator 10, the delta pressure rise (gain) with increasing flow rate is minimized because the flow path stream has low coefficient of drag forces. It should also be appreciated that the valve member 50 becomes a minor factor in the flow path of the valve regulator 10 due to its aerodynamic shape because the spring and flow rate pressure (velocity) are dominant.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A regulator valve for a fuel pump of a vehicle comprising:
a valve housing adapted to be disposed in an outlet member of the fuel pump;
a valve adjuster disposed in said valve housing;
a valve seat disposed within said valve housing and spaced from said valve adjuster; and
a valve member having an aerodynamic shape disposed within said valve housing and having a closed position to engage said valve seat to prevent fuel from flowing through the outlet member and an open position determined by said valve adjuster to allow fuel to flow through the outlet member.

2. A regulator valve as set forth in claim 1 wherein said valve member has a hub and a stem extending axially from said hub.

3. A regulator valve as set forth in claim 2 wherein said hub has a generally airfoil hull shape.

4. A regulator valve as set forth in claim 2 wherein said hub has a cone tip.

5. A regulator valve as set forth in claim 4 wherein said tip has an inclusive angle of sixty-four degrees.

6. A regulator valve as set forth in claim 2 wherein said valve seat includes an aperture extending axially therethrough.

7. A regulator valve as set forth in claim 6 wherein said valve seat has a recess at one end thereof and communicating with said aperture to receive and nest said hub of said valve member in said closed position.

8. A regulator valve as set forth in claim 2 wherein said valve adjuster has a cavity extending axially therein to receive said stem and guide said stem in said passageway.

9. A regulator valve as set forth in claim 5 wherein said valve guide includes a head extending radially and a shaft extending axially with a plurality of threads to engage said valve housing.

10. A regulator valve as set forth in claim 1 wherein said valve seat has an annular flange extending radially to engage said valve housing.

11. A regulator valve as set forth in claim 2 including a spring disposed about said stem to urge said hub of said valve member toward said valve seat.

12. A regulator valve for a fuel pump of a vehicle comprising:
a valve housing adapted to be disposed in an outlet member of the fuel pump, said valve housing having a passageway extending axially therethrough;
a valve adjuster disposed in said passageway of said valve housing;
a valve seat disposed in said passageway of said valve housing and spaced axially from said valve adjuster; and
a valve member having a hub of an aerodynamic shape and a stem extending axially from said hub, said valve member being disposed within said passageway of said valve housing and having a closed position to engage said valve seat to prevent fuel from flowing through the outlet member and an open position to engage said valve adjuster to allow fuel to flow through the outlet member.

13. A regulator valve as set forth in claim 12 including a spring disposed about said stem to urge said hub of said valve member toward said valve seat.

14. A regulator valve as set forth in claim 12 wherein said hub has a cone tip.

15. A regulator valve as set forth in claim 14 wherein said tip has an inclusive angle of sixty-four degrees.

16. A regulator valve as set forth in claim 12 wherein said valve adjuster has a cavity extending axially therein to receive said stem and guide said stem in said passageway.

17. A regulator valve as set forth in claim 12 wherein said valve guide includes a head extending radially and a shaft extending axially with a plurality of threads to engage said valve housing.

18. A regulator valve as set forth in claim 12 wherein said valve seat includes an aperture extending axially therethrough.

19. A regulator valve as set forth in claim 17 wherein said valve seat has a recess at one end thereof and communicating with said aperture to receive said hub and allow said cone to extend into said aperture when said valve member is in said closed position.

20. A regulator valve for a fuel pump of a vehicle comprising:
a valve housing adapted to be disposed in an outlet member of the fuel pump, said valve housing having a body portion with a passageway extending axially therethrough;
a valve adjuster disposed in said passageway and including a head extending radially and a shaft extending axially from said head with a plurality of threads, said shaft having a cavity extending axially therein;
a valve seat disposed within said passageway of said valve housing and spaced axially from said valve adjuster, said valve seat including a second aperture extending axially therethrough;
a valve member disposed within said valve housing and having a hub of an aerodynamic shape with a cone tip and a stem extending axially from said hub and received in said cavity; and
a spring disposed about said stem to urge said hub of said valve member toward said valve seat, said hub having a closed position to engage said valve seat and close said second aperture to prevent fuel from flowing through the outlet member and an open position to allow fuel to flow through said second aperture.
